(19) United States
(12) Patent Application Publication
(10) Pub. No.: US 2023/0189783 A1
(43) Pub. Date: Jun. 22, 2023

(54) SYSTEM AND METHOD FOR AN AGRICULTURAL APPLICATOR

(71) Applicants: CNH Industrial America LLC, New Holland, PA (US); Kansas State University Research Foundation, Manhattan, KS (US)

(72) Inventors: Andrew W. Harmon, Sheboygan, WI (US); Ajay Sharda, Manhattan, KS (US)

(21) Appl. No.: 17/559,349

(22) Filed: Dec. 22, 2021

(51) Int. Cl. A01M 7/00; A01C 23/00

(52) U.S. Cl. CPC A01M 7/0057; A01C 23/007; A01C 23/008; A01M 7/0089

(57) ABSTRACT

An agricultural system can include a boom assembly supporting one or more nozzle assemblies there along. A boom adjustment system can be operably coupled with the boom assembly. A sensing system can be configured to capture data indicative of one or more application variables. A computing system can be communicatively coupled to the boom adjustment system and the sensing system. The computing system can be configured to receive, from the sensing system, the data associated with the one or more application variables, calculate a spray quality index based on the data associated with the one or more application variables, and generate an output to change a position of the boom assembly through the boom adjustment system based at least in part on the calculated spray quality index deviating from a defined range.

### FIELD

The present disclosure generally relates to agricultural implements and, more particularly, to systems and methods for monitoring a spray operation, such as by monitoring one or more application variables during the spray operation.

### BACKGROUND

Various types of work vehicles utilize applicators (e.g., sprayers, floaters, etc.) to deliver an agricultural product to a ground surface of a field. The agricultural product may be in the form of a solution or mixture, with a carrier (such as water) being mixed with one or more active ingredients (such as an herbicide, fertilizer, fungicide, a pesticide, or another product).

The applicators may be pulled as an implement or self-propelled and can include a tank, a pump, a boom assembly, and a plurality of nozzles carried by the boom assembly at spaced locations. The boom assembly can include a pair of boom arms, with each boom arm extending to either side of the applicator when in an unfolded state. Each boom arm may include multiple boom arm sections, each with a number of nozzle assemblies (also sometimes referred to as spray tips).

The nozzle assemblies on the boom assembly disperse the agricultural product carried by the applicator onto the field. During a spray operation, however, various factors may affect a quality of application of the agricultural product to the field. Accordingly, an improved system and method for monitoring the quality of application of the agricultural product to the field would be welcomed in the technology.

### BRIEF DESCRIPTION

Aspects and advantages of the technology will be set forth in part in the following description, or may be obvious from the description, or may be learned through practice of the technology.

In some aspects, the present subject matter is directed to an agricultural system includes a boom assembly supporting one or more nozzle assemblies there along. A boom adjustment system is operably coupled with the boom assembly. A sensing system is configured to capture data indicative of one or more application variables. A computing system is communicatively coupled to the boom adjustment system and the sensing system. The computing system is configured to receive, from the sensing system, the data associated with the one or more application variables, calculate a spray quality index based on the data associated with the one or more application variables, the spray quality index representing a metric indicative of a spray operation coverage of a portion of a ground surface, and generate an output to change a position of the boom assembly through the boom adjustment system based at least in part on the calculated spray quality index deviating from a defined range.

In some aspects, the present subject matter is directed to a method for an agricultural application operation. The method includes receiving, through a sensing system, a first set of data indicative of one or more application variables. The method also includes calculating, with a computing system, a first spray quality index based on the first set of data associated with the one or more application variables, the spray quality index representing a metric indicative of a spray operation coverage of a portion of a ground surface. The method further includes altering, through a boom adjustment system, a boom assembly position from a first position to a second position when the first spray quality index deviates from a predefined range. Lastly, the method includes receiving, through the sensing system, a second set of data indicative of one or more application variables.

In some aspects, the present subject matter is directed to an agricultural system that includes a boom assembly supporting one or more nozzle assemblies there along. A boom adjustment system is operably coupled with the boom assembly. A sensing system is configured to capture data indicative of one or more application variables. A computing system is communicatively coupled to the boom adjustment system and the sensing system. The computing system being configured to receive, from the sensing system, the data associated with the one or more application variables and generate an output to change a position of the boom assembly through the boom adjustment system based at least in part on the one or more application variables deviating from a defined operating range.

These and other features, aspects, and advantages of the present technology will become better understood with reference to the following description and appended claims. The accompanying drawings, which are incorporated in and constitute a part of this specification, illustrate embodiments of the technology and, together with the description, serve to explain the principles of the technology.

### BRIEF DESCRIPTION OF THE DRAWINGS

A full and enabling disclosure of the present technology, including the best mode thereof, directed to one of ordinary skill in the art, is set forth in the specification, which makes reference to the appended figures, in which:

FIG. 1 illustrates a perspective view of an agricultural work vehicle in accordance with aspects of the present subject matter;

FIG. 2 illustrates a side view of the work vehicle in accordance with aspects of the present subject matter;

FIG. 3 is an enhanced view of section III of FIG. 1 illustrating a rear view of a portion of a boom assembly in accordance with aspects of the present subject matter;

FIG. 4 is a front perspective view of the boom assembly in accordance with aspects of the present subject matter;

FIG. 5 is a side perspective view of the boom assembly in accordance with aspects of the present subject matter;

FIG. 6 is a side perspective view of the boom assembly in accordance with aspects of the present subject matter;

FIG. 7 is a partial front perspective view of the boom assembly in accordance with aspects of the present subject matter;

FIG. 8 illustrates a block diagram of components of the agricultural applicator system in accordance with aspects of the present subject matter; and

FIG. 9 illustrates a flow diagram of a method for an agricultural application operation in accordance with aspects of the present subject matter.

Repeat use of reference characters in the present specification and drawings is intended to represent the same or analogous features or elements of the present technology.

### DETAILED DESCRIPTION

Reference now will be made in detail to embodiments of the disclosure, one or more examples of which are illustrated in the drawings. Each example is provided by way of explanation of the discourse, not limitation of the disclosure. In fact, it will be apparent to those skilled in the art that various modifications and variations can be made in the present disclosure without departing from the scope or spirit of the disclosure. For instance, features illustrated or described as part can be used with another embodiment to yield a still further embodiment. Thus, it is intended that the present disclosure covers such modifications and variations as come within the scope of the appended claims and their equivalents.

In this document, relational terms, such as first and second, top and bottom, and the like, are used solely to distinguish one entity or action from another entity or action, without necessarily requiring or implying any actual such relationship or order between such entities or actions. The terms “comprises,” “comprising,” or any other variation thereof, are intended to cover a non-exclusive inclusion, such that a process, method, article, or apparatus that comprises a list of elements does not include only those elements but may include other elements not expressly listed or inherent to such process, method, article, or apparatus. An element preceded by “comprises... a” does not, without more constraints, preclude the existence of additional identical elements in the process, method, article, or apparatus that comprises the element.

As used herein, the terms “first,” “second,” and “third” may be used interchangeably to distinguish one component from another and are not intended to signify a location or importance of the individual components. The terms “coupled,” “fixed,” “attached to,” and the like refer to both direct coupling, fixing, or attaching, as well as indirect coupling, fixing, or attaching through one or more intermediate components or features, unless otherwise specified herein. The terms “upstream” and “downstream” refer to the relative direction with respect to an agricultural product within a fluid circuit. For example, “upstream” refers to the direction from which an agricultural product flows, and “downstream” refers to the direction to which the agricultural product moves. The term “selectively” refers to a component’s ability to operate in various states (e.g., an ON state and an OFF state) based on manual and/or automatic control of the component.

Furthermore, any arrangement of components to achieve the same functionality is effectively “associated” such that the functionality is achieved. Hence, any two components herein combined to achieve a particular functionality can be seen as “associated with” each other such that the desired functionality is achieved, irrespective of architectures or intermedial components. Likewise, any two components so associated can also be viewed as being “operably connected” or “operably coupled” to each other to achieve the desired functionality, and any two components capable of being so associated can also be viewed as being “operably couplable” to each other to achieve the desired functionality. Some examples of operably couplable include, but are not limited to, physically mateable, physically interacting components, wirelessly interactable, wirelessly interacting components, logically interacting, and/or logically interactable components.

The singular forms “a,” “an,” and “the” include plural references unless the context clearly dictates otherwise.

Approximating language, as used herein throughout the specification and claims, is applied to modify any quantitative representation that could permissibly vary without resulting in a change in the basic function to which it is related. Accordingly, a value modified by a term or terms, such as “about,” “approximately,” “generally,” and “substantially,” is not to be limited to the precise value specified. In at least some instances, the approximating language may correspond to the precision of an instrument for measuring the value, or the precision of the methods or apparatus for constructing or manufacturing the components and/or systems. For example, the approximating language may refer to being within a ten percent margin.

Moreover, the technology of the present application will be described in relation to exemplary embodiments. The word “exemplary” is used herein to mean “serving as an example, instance, or illustration.” Any embodiment described herein as “exemplary” is not necessarily to be construed as preferred or advantageous over other embodiments. Additionally, unless For instance identified otherwise, all embodiments described herein should be considered exemplary.

As used herein, the term “and/or,” when used in a list of two or more items, means that any one of the listed items can be employed by itself, or any combination of two or more of the listed items can be employed. For example, if a composition or assembly is described as containing components A, B, and/or C, the composition or assembly can contain A alone; B alone; C alone; A and B in combination; A and C in combination; B and C in combination; or A, B, and C in combination.

In general, the present subject matter is directed to a system for various agricultural operations. In some instances, an agricultural system can include a boom assembly supporting one or more nozzle assemblies there along. The nozzle assemblies may be configured to selectively dispense an agricultural product therefrom.

A boom adjustment system may be operably coupled with the boom assembly. The boom adjustment system may allow for height adjustment of the frame, the first boom arm, and/or the second boom arm simultaneously relative to the ground. Additionally or alternatively, the boom adjustment system may allow for height adjustment of the frame, the first boom arm, and/or the second boom arm independently of one another relative to the ground. Likewise, the boom adjustment system may allow for adjustment in a tilt of the frame, the first boom arm, and/or the second boom arm simultaneously relative to the ground. Additionally or alternatively, the boom adjustment system may allow for adjustment in a tilt of the frame, the first boom arm, and/or the second boom independently of one another relative to the ground.

A sensing system may be configured to capture data indicative of one or more application variables. In general, the sensing system may be configured to capture data indicative of one or more application variables associated with a spray operation in which an agricultural product is dispensed by the nozzle assemblies onto an underlying ground surface. The application variable may, in turn, be indicative of the quality of the spray operation, such as whether a target application rate of the agricultural product is within a defined range.

A computing system may be communicatively coupled to the boom adjustment system and the sensing system. The computing system may be configured to receive the data associated with the one or more application variables from the sensing system. The computing system may further be configured to calculate a spray quality index based on the data associated with the one or more application variables, the spray quality index representing a metric indicative of a spray operation coverage of a portion of a ground surface. In addition, the computing system may be configured to generate an output to change a position of the boom assembly through the boom adjustment system based at least in part on the calculated spray quality index deviating from a defined range.

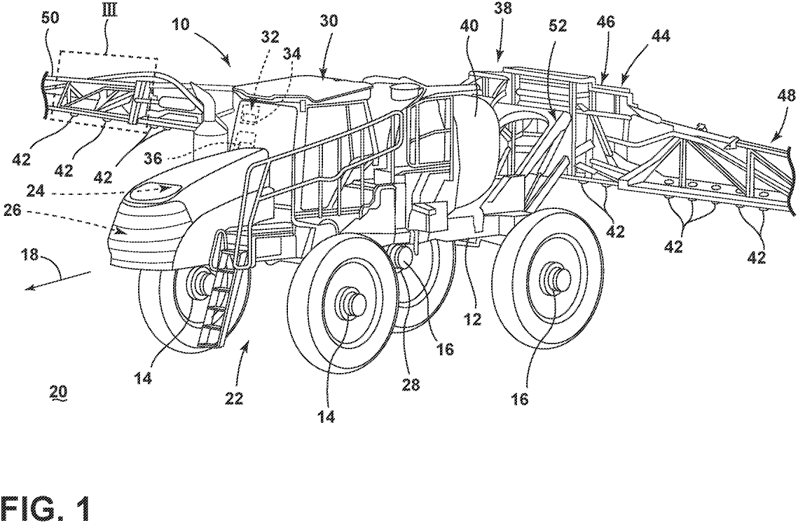

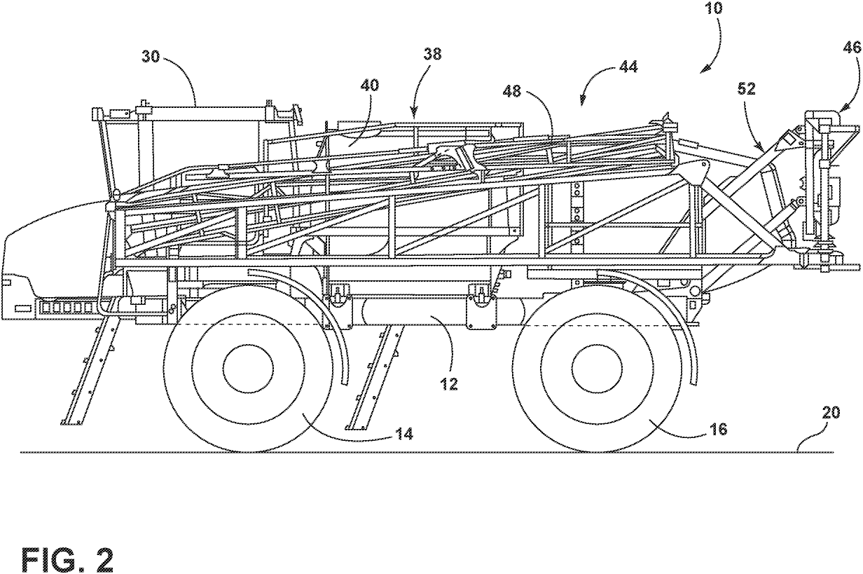

Referring now to FIGS. 1 and 2, a sprayer 10 is generally illustrated as a self-propelled agricultural applicator. However, in alternate embodiments, the sprayer 10 may be configured as any other suitable type of applicator configured to perform agricultural application operations, such as a tractor or other vehicle configured to haul or tow an application implement.

In various embodiments, the sprayer 10 may include a chassis 12 configured to support or couple to a plurality of components. For example, front and rear wheels 14, 16 may be coupled to the chassis 12. The wheels 14, 16 may be configured to support the sprayer 10 relative to a ground surface 20 and move the sprayer 10 in a direction of travel (e.g., as indicated by arrow 18 in FIG. 1). In this regard, the sprayer 10 may include a powertrain control system 22 that includes a power plant 24, such as an engine, a motor, or a hybrid engine-motor combination, a transmission or hydraulic propel system 26 configured to transmit power from the engine to the wheels 14, 16, and/or a brake system 28.

The chassis 12 may also support a cab 30, or any other form of user’s station, for permitting the user to control the operation of the sprayer 10. For instance, as shown in FIG. 1, the sprayer 10 may include a user interface 32 having a display 34 for providing messages and/or alerts to the user and/or for allowing the user to interface with the vehicle’s controller through one or more user input devices 36 (e.g., levers, pedals, control panels, buttons, and/or the like).

The chassis 12 may also support a product application system 38 that includes one or more tanks 40, such as a rinse tank and/or a product tank, and one or more nozzle assemblies 42. The product tank is generally configured to store or hold an agricultural product, such as a pesticide, a fungicide, a rodenticide, a fertilizer, a nutrient, and/or the like. The agricultural product is conveyed from the product tank through plumbing components, such as interconnected pieces of tubing, for release onto the underlying ground surface 20 (e.g., plants and/or soil) through the one or more nozzle assemblies 42.

The one or more nozzle assemblies 42 may be operably coupled with a boom assembly 44. As shown in FIGS. 1 and 2, the boom assembly 44 can include a frame 46 that supports first and second boom arms 48, 50, which may be orientated in a cantilevered nature. The first boom arm 48 and the second boom arm 50 are generally movable between an operative or unfolded position (FIG. 1) and an inoperative or folded position (FIG. 2). When distributing the product, the first boom arm 48 and/or the second boom arm 50 extends laterally outward from the sprayer 10 to cover swaths of the underlying ground surface 20, as illustrated in FIG. 1. However, to facilitate transport, the first boom arm 48 and/or the second boom arm 50 of the boom assembly 44 may be independently folded forwardly or rearwardly into the inoperative position, thereby reducing the overall width of the sprayer 10, or in some examples, the overall width of a towable implement when the applicator is configured to be towed behind the sprayer 10.

In some examples, the boom assembly 44 may include a boom adjustment system 52. The boom adjustment system 52 may allow for height adjustment of the frame 46, the first boom arm 48, and/or the second boom arm 50 simultaneously relative to the ground surface 20. Additionally or alternatively, the boom adjustment system 52 may allow for height adjustment of the frame 46, the first boom arm 48, and/or the second boom arm 50 independently of one another relative to the ground surface 20. Likewise, the boom adjustment system 52 may allow for adjustment in a tilt of the frame 46, the first boom arm 48, and/or the second boom arm 50 simultaneously relative to the ground surface 20. Additionally or alternatively, the boom adjustment system 52 may allow for adjustment in a tilt of the frame 46, the first boom arm 48, and/or the second boom independently of one another relative to the ground surface 20.

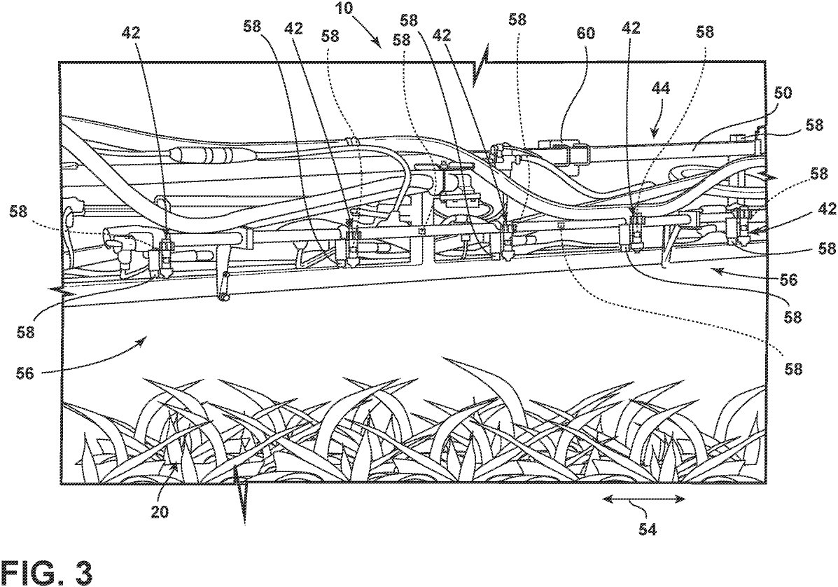

Referring to FIG. 3, in several embodiments, the nozzle assemblies 42 may be mounted on and/or coupled to the first and/or second boom arms 48, 50 of the boom assembly 44, with the nozzle assemblies 42 being spaced apart from each other along a lateral direction 54. Furthermore, fluid conduits may fluidly couple the nozzle assemblies 42 to the tank 40. In this respect, as the sprayer 10 travels across the ground surface 20 in the direction of travel 18 to perform a spraying operation thereon, the agricultural product moves from the tank 40 through the fluid conduits to each of the nozzle assemblies 42. The nozzles may, in turn, dispense or otherwise spray a fan of the agricultural product onto the underlying ground surface 20. For example, the nozzle assemblies 42 may include flat fan nozzles configured to dispense a flat fan of the agricultural product. However, in alternative embodiments, the nozzle assemblies 42 may include any other suitable types of nozzles, such as dual pattern nozzles and/or hollow cone nozzles.

With further reference to FIG. 3, during a spray operation, various application variables may affect a quality of the application of the agricultural product to the ground surface 20, which can be computed into a spray quality index. The spray quality index may represent a metric indicative of a spray operation coverage of a portion of a ground surface 20. In some instances, the spray quality index may be used to determine whether the agricultural product was applied to various portions of the ground surface 20 within a defined range and/or misapplied to various portions of the ground surface 20 by deviating from the defined range. In some instances, the defined range may be correlated to a defined application rate.

In several embodiments, the one or more application variables that may affect the spray quality can include at least one of an airflow at each nozzle assembly 42, a nozzle tip size and style, which agricultural product is being applied, an incorrect agricultural product application rate, inclement weather as determined by meeting one or more criteria, an agricultural product application rate or pressure deviating from a predefined range, boom assembly movement (e.g., jounce) deviating from a movement range, a sprayer deviating from a predefined speed, a sprayer acceleration/deceleration deviating from a predefined range, a turning radius deviating from predefined criteria, and/or any other variable.

In accordance with aspects of the present subject matter, to monitor the one or more application variables, the vehicle may include a sensing system 56. In general, the sensing system 56 may be configured to capture data indicative of one or more application variables associated with the application of the agricultural product to the underlying ground surface 20. The application variable may, in turn, be indicative of the quality of the spray operation, such as whether a target application rate of the agricultural product is within a defined range.

The sensing system 56 may include one or more sensors 58, a weather station 60, and/or any other assembly, which may be installed on the sprayer 10 and/or the boom assembly 44. In various examples, the one or more sensors 58 and/or the weather station 60 may be configured to capture data of an associated nozzle assembly 42 and/or the one or more sensors 58 may be configured to capture data indicative of a component that is then related to the nozzle assemblies 42. For example, as illustrated in FIG. 3, the one or more sensors 58 may be positioned proximate to the nozzle assemblies 42 and/or within the nozzle assemblies 42 to capture data indicative of various application variables associated with the respective nozzle assembly 42. Additionally or alternatively, as illustrated in FIG. 3, the data from the one or more sensors 58 and/or the weather station 60 may be used to determine an application variable of each nozzle assembly 42. For instance, various forces may be placed on the boom assembly 44 causing the boom assembly 44 and, consequently, the nozzle assemblies 42 positioned along the boom assembly 44, to be deflected or repositioned relative to the frame 46 and/or the sprayer 10. In embodiments that utilize a boom arm 50 that is supported by the frame 46 in a cantilevered orientation (or any other nonuniform orientation), such as the one illustrated in FIG. 3, an outer nozzle assembly 42 will have a greater deflection magnitude from its default position than an inner nozzle assembly 42. Once the deflective force is overcome and/or no longer present, the boom arm 50 will move back towards its default position. In some embodiments, the movement of the boom arm 50 may generally occur as harmonic oscillations. During the oscillations, an acceleration or speed of an inner nozzle assembly 42 may be less than the outer nozzle assembly 42 due to the varied deflection magnitudes along the boom arm 50. In addition, once the boom assembly 44 is deflected, a path of movement of the inner nozzle assembly 42 may be non-parallel to a path of movement of the outer nozzle assembly 42. In some embodiments, a boom speed and/or boom acceleration of the boom arm 50 may be calculated based on the detected and/or calculated position of various portions of the boom arm 50 based on data from the position sensor at known periods to define a boom deflection model. The boom deflection model may map a deflection of each nozzle assembly 42, a nozzle assembly speed or acceleration, and/or a path of movement of each nozzle assembly 42 relative to the frame 46. In various embodiments, the boom deflection model may be determined through various geometric equations, lookup tables (LUTs), and/or any other method to determine a position, a speed, and/or an acceleration of each nozzle assembly 42. Due to the varied nozzle assembly speed and/or path of the movement of each nozzle assembly 42, an airflow speed and/or direction at each nozzle assembly 42 may be varied relative to one another. As such, the boom deflection model, the speed of the sprayer 10, and the data from the sensing system 56 may be used to determine a spray quality index.

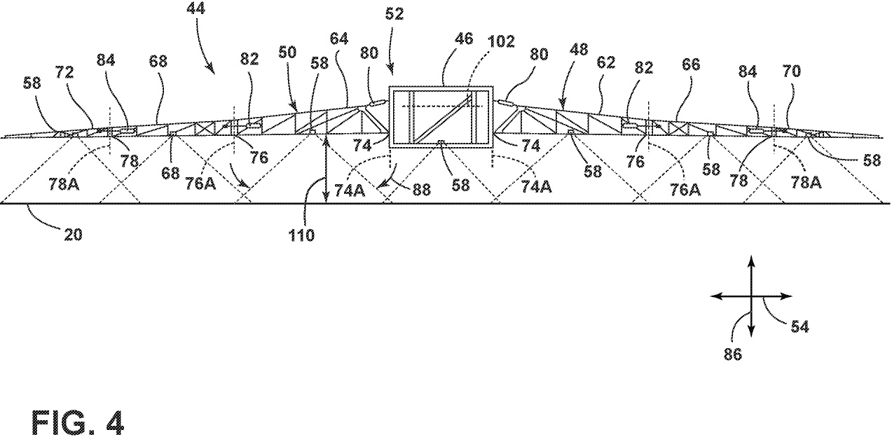

Referring now to FIGS. 4-7, in some instances, the sprayer 10 may be configured to alter one or more components thereof based on the data captured by the sensing system 56. For example, the one or more components may be altered when the spray quality index deviates from an overall defined range and/or a spray quality of a single nozzle assembly 42 deviates from a defined range. Additionally or alternatively, the one or more components may be altered when the one or more application variables deviate from a defined operating range. Additionally or alternatively, the one or more components may be altered based on environmental factors to adjust the coverage or drift of the dispensed product. Additionally or alternatively, the one or more components may be altered based on the specific product to be dispensed from the sprayer 10 and/or for any other purpose.

In some instances, the one or more components may at least include the boom adjustment system 52 operably coupled with the sprayer 10 and/or the boom assembly 44. As shown, in some embodiments, the boom assembly 44 includes the frame 46, a right inner boom section 62 and a left inner boom arm section 64 pivotably coupled to the frame 46, a right boom arm section 66, and a left middle boom arm section 68 pivotably coupled to the respective right boom arm section 62 and left inner boom arm section 64, and an outer right boom arm section 70 and an outer left boom arm section 72 pivotably coupled to the respective the right boom arm section 66 and the left middle boom arm section 68. For example, each of the inner boom arm sections 62, 64 can be pivotably coupled to the frame 46 at pivot joints 74. Similarly, the middle boom arm sections 66, 68 can be pivotally coupled to the respective inner boom arm sections 62, 64 at pivot joints 76 while the outer boom arm sections 70, 72 can be pivotably coupled to the respective middle boom arm sections 66, 68 at pivot joints 78. The pivot joints 74, 76, 78 may be configured to allow relative pivotal motion between adjacent boom arm sections of the boom assembly 44.

Additionally, as shown in FIG. 4, the boom assembly 44 may include inner fold actuators 80 coupled between the inner boom arm sections 62, 64 and the frame 46 to enable pivoting or folding between the fully-extended and transport positions. For example, by retracting/extending the inner fold actuators 80, the inner boom arm sections 62, 64 may be pivoted or folded relative to the frame 46 about a pivot axis 74A defined by the pivot joints 74. Moreover, the boom assembly 44 may also include middle fold actuators 82 coupled between each inner boom arm section 62, 64 and its adjacent middle boom arm section 66, 68 and outer fold actuators 84 coupled between each middle boom arm section 66, 68 and its adjacent outer boom arm section 70, 72. As such, by retracting/extending the middle and outer fold actuators 82, 84, each middle and outer boom arm section 66, 68, 70, 72 may be pivoted or folded relative to its respective inwardly adjacent boom arm section 62, 64, 66, 68 about a respective pivot axis 76A, 78A.

In various embodiments, the boom assembly 44 may be moved up and/or down to adjust the distance between the boom assembly 44 and the ground surface 20 along a vertical direction 86. Additionally or alternatively, the vertical positioning of the various individual boom arm sections of the boom assembly 44 may also be adjusted relative to the ground surface 20. Additionally or alternatively, an application angle of the nozzle assemblies 42 may be adjusted relative to the ground surface 20 to alter spray coverage. For example, a tilt angle (e.g., as indicated by arrow 88 in FIG. 4) of the boom assembly 44 may be adjusted relative to the vertical direction 86 such that the application angle of the nozzle assemblies 42 is correspondingly adjusted.

In several embodiments, the sensing system 56 may be configured to capture data indicative of an orientation or position of the boom assembly 44 relative to the ground surface 20. In several embodiments, an orientation sensor 58 may be positioned on each boom arm section 46, 62, 64, 66, 68, 70, 72 of the boom assembly 44. However, in alternative embodiments, the sensor 58 may be positioned at any other suitable location on and/or coupled to any other suitable component of the agricultural sprayer 10.

Referring now to FIGS. 4-7, the boom adjustment system 52 may include a linkage assembly 90 configured to couple the boom assembly 44 to the sprayer 10, e.g., via a mount 92 rigidly coupled to the chassis 12. In several embodiments, the linkage assembly 90 includes one or more support arms 94, one or more lift actuators 96, and one or more tilt actuators 98. In the illustrated embodiment, the support arm 94 is generally shown as being an upper link of the linkage assembly 90 and the tilt actuator 98 is shown as being a lower link of the linkage assembly 90. However, it will be appreciated that the support arm 94 and tilt actuator 98 may instead be arranged in any other suitable configuration that allows the boom adjustment system 52 to function as described herein.

In the illustrated embodiments, the support arm 94 is pivotably coupled between the mount 92 and the frame 46 of the boom assembly 44. More particularly, each support arm 94 may have a fixed length defined between a first end portion 94A of the support arm 94 and a second end portion 94B of the support arm 94. The first end portion 94A of the support arm 94 is pivotably coupled to the mount 92, e.g., via a first pivot joint 100A, and the second end portion 94B of the support arm 94 is pivotably coupled to the frame 46 of the boom assembly 44, e.g., via a second pivot joint 100B. The support arm 94, together with the lift actuator 96, may be configured to support the weight of the boom assembly 44 relative to the sprayer 10.

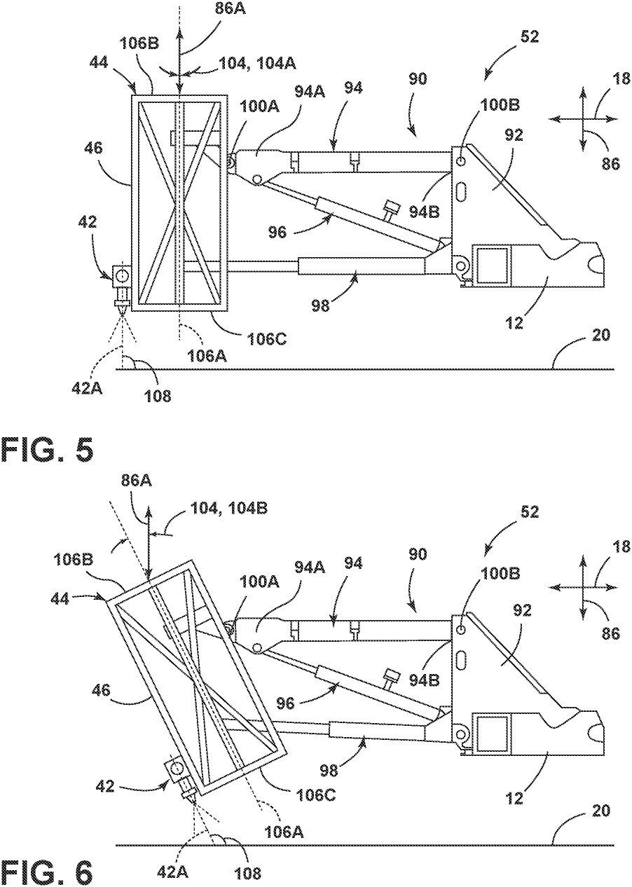

As shown in FIGS. 5 and 6, the lift actuator 96 is pivotably coupled between a support arm 94 and the mount 92. The lift actuator may be configured to have a selectively variable length. For example, in some embodiments, the lift actuator 96 may be configured as a fluid-driven actuator, such as a hydraulic or pneumatic cylinder. However, in alternative embodiments, the lift actuator 96 may be configured as any other suitable type of actuator, such as an electric linear actuator. As such, the lift actuator 96 may be configured to extend or retract to pivot the respective support arm 94 about the second pivot joint 100B such that the boom assembly 44 as a whole is raised or lowered along the vertical direction 86 relative to the chassis 12. Thus, the distance between the boom assembly 44 and the ground surface 20 may generally be varied by actuating the lift actuator 96.

Further, as shown in FIGS. 5 and 6, the tilt actuator 98 is pivotably coupled between the mount 92 and the frame 46 of the boom assembly 44. Similar to the lift actuator 96, the tilt actuator 98 may also be configured to have a selectively variable length. For example, in some embodiments, the tilt actuator 98 may be configured as a fluid-driven actuator, such as a hydraulic or pneumatic cylinder. However, in alternative embodiments, the tilt actuator 98 may be configured as any other suitable type of actuator, such as an electric linear actuator. Regardless, the tilt actuator 98 may be configured to extend or retract to pivot or tilt the boom assembly 44 as a whole about a tilt axis 102 (FIG. 4) to adjust or change a corresponding tilt angle 104 of the boom assembly 44. The tilt axis 102 may be at least partially defined by the first pivot joint 100A coupling the first end portion 94A of the support arm 94 to the mount 92. In some embodiments, the tilt axis 102 may be parallel to an axle of the agricultural sprayer 10 (e.g., an axle extending between rear wheels 16 perpendicular to the direction of travel 18) and parallel to the lateral direction 54. The tilt angle 104 of the boom assembly 44 may generally be defined between a central reference plane 106A extending between opposed top and bottom end portions 106B, 106C of the frame 46 and a vertical reference plane 58A extending in the vertical direction 86.

Additionally, as shown in FIGS. 5 and 6, each nozzle assembly 42 may be operably coupled to the boom assembly 44 (e.g., the frame 46) at a given orientation relative to the boom assembly 44. In some embodiments, the tilt actuator 98 may be configured to extend or retract to pivot or tilt the boom assembly 44 to adjust or change a corresponding application angle 108 of each nozzle assembly 42. The application angle 108 of the nozzle assembly 42 may generally be defined between a spray axis 42A, the spray axis 42A extending in the general direction of the spray of fluid from the nozzle assembly 42, and the ground surface 20.

In some embodiments, by extending/retracting the tilt actuator 98, the tilt angle 104 of the boom assembly 44 may be adjusted such that the boom assembly 44 is actuated between a substantially vertical orientation (e.g., as shown in FIG. 5) and a substantially non-vertical orientation (e.g., as shown in FIG. 6). For instance, as shown in FIG. 5, when in its substantially vertical orientation, the boom assembly 44 may define a substantially vertical operational tilt angle 104A that is equal or substantially equal to zero, such as a tilt angle 104A that is greater than or equal to zero degrees and less than 5 degrees, or greater than or equal to zero degrees and less than 2.5 degrees and/or any other subranges defined therebetween. When the boom assembly 44 is in its substantially vertical orientation, the nozzle assembly 42 may be generally oriented perpendicularly to the ground surface 20, such as at an application angle 108 that is substantially equal to 90 degrees.

In contrast, as shown in FIG. 6, when in its substantially non-vertical orientation, the boom assembly 44 may define a substantially non-vertical operational tilt angle 104B. In some instances, the substantially non-vertical orientation may allow the fold actuators of the boom assembly 44 to be used to individually adjust the vertical position of the various boom arm sections relative to the ground surface 20. For instance, at the substantially non-vertical orientation, the various pivot axes 74A, 76A, 78A are oriented relative to the vertical direction 86 at an angle generally corresponding to the non-vertical operational tilt angle 104B, thereby allowing the boom arm sections to be actuated via the fold actuators 80, 82, 84 in a direction having a vertical component of movement. Additionally, when the boom assembly 44 is in its non-vertical orientation, the nozzle assembly 42 may be generally oriented non-perpendicularly relative to the ground surface 20, such as at an application angle 108 that is substantially less than or greater than ninety (90) degrees.

Referring further to FIGS. 4-7, during the operation of the agricultural sprayer 10, the various boom arm sections of the boom assembly 44 may be maintained at a given vertical distance from the ground surface 20 to maintain the spray quality index within a defined range. In general, as the distance between the boom assembly 44 and ground surface 20 increases, the ground surface 20 that the nozzle assembly 42 may cover with spray increases, as well as drift. Thus, the distance 110 may be chosen based on the desired coverage of the nozzle assembly 42. In general, the boom assembly 44 may be raised or lowered by the lift actuator 96 to adjust the vertical distance between the boom assembly 44 and the ground surface 20 to the desired distance. However, in some instances, as the boom assembly 44 traverses a ground surface 20, the ground surface 20 may not be level such that one or more sections 62, 64, 66, 68, 70, 72 of the boom assembly 44 are closer or farther away from the ground surface 20 than desired. In such instances, control of the operation of the lift actuator 96, alone, may be insufficient to maintain the desired spacing between the various boom arm sections and the ground surface 20.

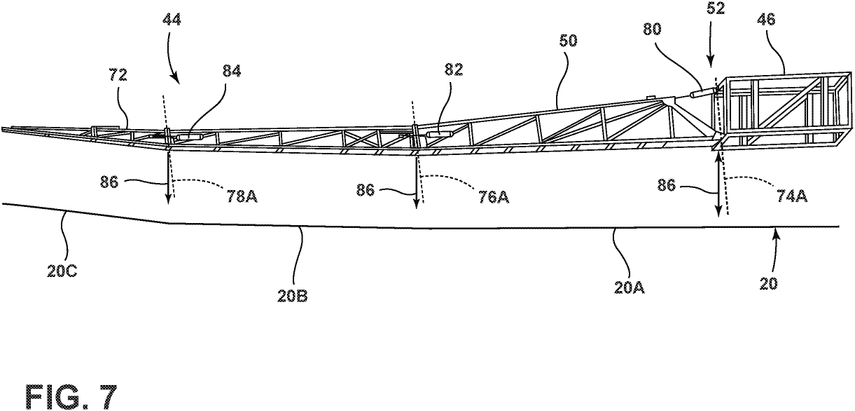

For instance, referring For instance to FIG. 7, an example is illustrated in which the ground surface 20 over which a portion of the boom assembly 44 extends is not level. For purposes of discussion, only the left side sections 64, 68, 72 of the boom assembly 44 are shown. However, it will be appreciated that the same or similar control actions as those described herein with reference to the left side sections 64, 68, 72 may also be taken for the right side sections 62, 66, 70 of the boom assembly 44.

As shown in FIG. 7, the first ground section 60A is generally flat, with the second and third ground sections 60B, 60C being angled upwardly relative to a first ground section 60A with progressively increasing slopes. In such an instance, without adjusting the orientation of the boom assembly 44 in the manner described herein, the vertical spacing or clearance between the boom assembly 44 and ground surface 20 would generally decrease as the boom assembly 44 extends outwardly from the frame 46 to the outer boom arm section 72. To accommodate the non-flat ground surface 20, the orientation or tilt angle 104 of the boom assembly 44 may be varied to allow relative vertical positioning of the individual boom arm sections to be adjusted to accommodate such a varying ground contour.

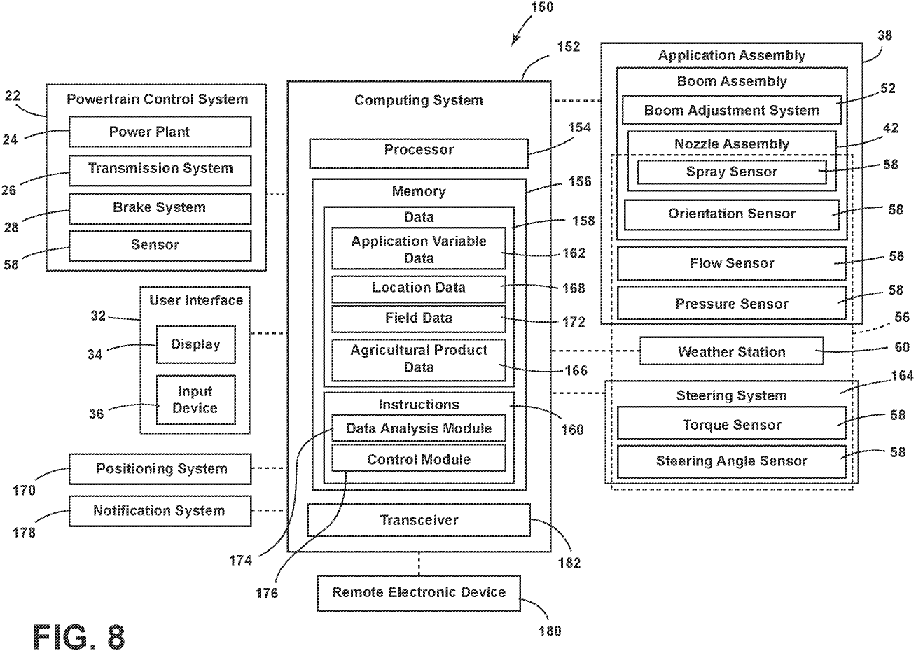

Referring now to FIG. 8, a schematic view of a system 150 for operating the sprayer 10 is illustrated in accordance with aspects of the present subject matter. In general, the system 150 will be described with reference to the sprayer 10 described above with reference to FIGS. 1-7. However, it should be appreciated by those of ordinary skill in the art that the disclosed system 150 may generally be utilized with agricultural machines having any other suitable machine configuration. Additionally, it should be appreciated that, for purposes of illustration, communicative links, or electrical couplings of the system 150 shown in FIG. 8 are indicated by dashed lines.

As shown in FIG. 8, the system 150 may include a computing system 152 operably coupled with the agricultural product application system 38 that may be configured to dispense an agricultural product through one or more nozzle assemblies 42 that may be positioned at least partially along the boom assembly 44 (FIG. 1). In several embodiments, the nozzle assemblies 42 may include a nozzle and a valve for activating the respective nozzle to perform a spray operation. The valves can include restrictive orifices, regulators, and/or the like to regulate the flow of agricultural product from the application system 38 that is emitted from each nozzle assembly 42. In various embodiments, the valves may be configured as electronically controlled valves that are controlled by a Pulse Width Modulation (PWM) signal for altering the application rate of the agricultural product.

In general, the computing system 152 may comprise any suitable processor-based device, such as a computing device or any suitable combination of computing devices. Thus, in several embodiments, the computing system 152 may include one or more processors 154 and associated memory 156 configured to perform a variety of computer-implemented functions. As used herein, the term “processor” refers not only to integrated circuits referred to in the art as being included in a computer, but also refers to a controller, a microcontroller, a microcomputer, a programmable logic controller (PLC), an application specific integrated circuit, and other programmable circuits. Additionally, the memory 156 of the computing system 152 may generally comprise memory elements including, but not limited to, a computer readable medium (e.g., random access memory (RAM)), a computer readable non-volatile medium (e.g., a flash memory), a floppy disk, a compact disc-read only memory (CD-ROM), a magneto-optical disk (MOD), a digital versatile disc (DVD) and/or other suitable memory elements. Such memory 156 may generally be configured to store information accessible to the processor 154, including data 158 that can be retrieved, manipulated, created, and/or stored by the processor 154 and instructions 160 that can be executed by the processor 154, when implemented by the processor 154, configure the computing system 152 to perform various computer-implemented functions, such as one or more aspects of the image processing algorithms and/or related methods described herein. In addition, the computing system 152 may also include various other suitable components, such as a communications circuit or module, one or more input/output channels, a data/control bus, and/or the like.

In various embodiments, the computing system 152 may correspond to an existing controller of the agricultural sprayer 10, or the computing system 152 may correspond to a separate processing device. For instance, in some embodiments, the computing system 152 may form all or part of a separate plug-in module or computing device that is installed relative to the sprayer 10 or boom assembly 44 to allow for the disclosed system 150 and method to be implemented without requiring additional software to be uploaded onto existing control devices of the sprayer 10 or the boom assembly 44.

In several embodiments, the data 158 may be stored in one or more databases. For example, the memory 156 may include an application variable database 162 for storing application variable data received from the sensing system 56 and/or any other device. Moreover, in addition to initial or raw sensor data and/or weather data received from the sensing system 56, final or post-processing application variable data (as well as any intermediate application variable data created during data processing) may also be stored within the application variable database 162.

In several embodiments, the sensing system 56 can include one or more spray sensors, orientation sensors, flow sensors, pressure sensors, steering sensors, a weather station 60, and/or any other sensing assembly. Each sensing assembly may be capable of capturing data that may be stored with the application variable database 162. For instance, the spray sensors (e.g., an imaging sensor, a LIDAR, a RADAR, or any other suitable type of sensor) may be configured to capture data related to the one or more spray fans. The orientation sensor (e.g., an imaging sensor, a LIDAR, a RADAR sensor, a Hall effect sensor, a gyroscope sensor, a magnetometer sensor, an accelerometer sensor, a yaw-rate sensor, a piezoelectric sensor, a position sensor, a complementary metal-oxide-semiconductor (CMOS) sensor, a pressure sensor, a capacitive sensor, an ultrasonic sensor, or any other suitable type of sensor) may be configured to capture data related to a position, angle, displacement, distance, speed, acceleration of any component of the boom assembly 44 and/or the nozzle assemblies 42. The one or more flow sensors (e.g., a diaphragm pressure sensor, a piston flow sensor, a strain gauge-based pressure sensor, an electromagnetic pressure sensor, a flow meter, and/or any other practicable sensor) 66 may be configured to capture data indicative of a flow condition, such as a flow pressure or flow velocity, within the flow paths of the product application system 38. The pressure sensor (e.g., a diaphragm pressure sensor, a piston pressure sensor, a strain gauge-based pressure sensor, an electromagnetic pressure sensor, or any other suitable type of sensor) may be configured to capture data indicative of the pressure of the agricultural product being supplied to or through the nozzle assemblies 42. The steering sensor (e.g., a torque sensor, a steering angle sensor, or any other suitable type of sensor) may be within a steering system 164 and configured to capture data related to an instantaneous steering direction of the sprayer 10 and/or data related to a torque on a steering wheel indicating a user’s intention for manipulating the steering system 164. Additionally, a powertrain control system sensor may be configured to capture data related to a component of the powertrain control system 22.

In addition, the weather station 60 may be configured to capture data indicative of a wind speed and direction at a defined position on the sprayer 10. The mobile weather station 60 can contain any sensor that may be found on a stationary weather station 60 that monitors one or more weather criteria, such as temperature, wind speed, wind direction, relative humidity, barometric pressure, cloud cover, and trends thereof.

In some embodiments, the memory 156 may also include an agricultural product database 166 that stores agricultural product information. The agricultural product information may include various information regarding the conditions and rates of application for an individual product that is to be applied to the ground surface 20. In some instances, the product information may be preloaded or sent to the sprayer 10 via wired or wireless communication therewith. Additionally or alternatively, the product information may be manually inputted into the database. In some embodiments, based on the selected product information, a different spray quality index and/or acceptable range may be selected.

Additionally, in several embodiments, the memory 156 may also include a location database 168 storing location information of the sprayer 10 and/or the boom assembly 44. For example, in some embodiments, the positioning system 170 may be configured to determine the location of the sprayer 10 and/or the boom assembly 44 by using a satellite navigation positioning system 170 (e.g. a GPS system, a Galileo positioning system, the Global Navigation satellite system (GLONASS), the BeiDou Satellite Navigation and Positioning system, a dead reckoning device, and/or the like). In such embodiments, the location determined by the positioning system 170 may be transmitted to the computing system 152 (e.g., in the form location coordinates) and subsequently stored within the location database 168 for subsequent processing and/or analysis.

In several embodiments, the location data stored within the location database 168 may also be correlated to the application variable data stored within the application variable database 162. For instance, in some embodiments, the location coordinates derived from the positioning system 170 and the application variable data captured by the sensing system 56 may both be time-stamped. In such embodiments, the time-stamped data may allow the data captured by the sensing system 56 to be matched or correlated to a corresponding set of location coordinates received from the positioning system 170, thereby allowing the location of the portion of the ground surface 20 associated with a given set of application variable data to be known (or at least capable of calculation) by the computing system 152.

Additionally, in some embodiments, such as the one shown in FIG. 8, the memory 156 may include a field database 172 for storing information related to a field formed from a bounded ground surface 20, such as field map data. In such embodiments, by matching each set of application variable data captured by the sensing system 56 to a corresponding set of location coordinates, the computing system 152 may be configured to generate or update a corresponding field map associated with the field, which may then be stored within the field database 172 for subsequent processing and/or analysis. For example, the application variable data captured by the sensing system 56 and/or the positioning system 170 may be mapped or otherwise correlated to the corresponding locations within the field map. Alternatively, based on the location data and the associated sensing system data, the computing system 152 may be configured to generate a field map that includes the geo-located application variable associated therewith.

With further reference to FIG. 8, in several embodiments, the instructions 160 stored within the memory 156 of the computing system 152 may be executed by the processor 154 to implement a data analysis module 174 and/or a control module 176. In general, the data analysis module 174 may be configured to analyze the initial or raw sensor data captured by the sensing system 56 and/or the positioning system 170 to allow the computing system 152 to calculate the spray quality index. For instance, the data analysis module 174 may be configured to execute one or more suitable data processing techniques or algorithms that allows the computing system 152 to analyze the sensor data, such as by applying corrections or adjustments to the data based on the sensor type, sensor resolution, and/or other variables associated with the sensing system 56 and/or the positioning system 170 by filtering the data to remove outliers, by implementing sub-routines or intermediate calculations to estimate the spray quality index based on one or more application variables, and/or by performing any other desired data processing-related techniques or algorithms. In some embodiments, the computing system 152 may be configured to analyze the data to determine a spray quality index for the analyzed section of the field and/or whether the spray quality index is within predefined ranges. In some embodiments, the computing system 152 may be configured to analyze the data to monitor each variable. In some instances, the computing system 152 may be configured to determine which variables cause variances in the spray quality index during the operation of the sprayer 10 if a deviation exists.

The active control module 176 may generate one or more outputs for various components communicatively coupled with the computing system 152 based on the results of the data analysis module 174. For example, the control module 176 may generate an output to change a position of the boom assembly 44 through the boom adjustment system 52 based at least in part on the calculated spray quality index deviating from a defined range and/or one or more application variables deviating from a defined range. In some instances, the change in the position of the boom assembly 44 may include altering a height of the boom assembly 44 relative to the ground surface 20. Additionally or alternatively, the change in the position of the boom assembly 44 may include altering a tilt of the boom assembly 44 relative to the ground surface 20. Additionally or alternatively, the change in the position of the boom assembly 44 may include altering a height of a first boom arm section 62, 64, 66, 68, 70, 72 of the boom assembly 44 relative to a second boom arm section 62, 64, 66, 68, 70, 72 of the boom assembly 44. Additionally or alternatively, the change in the position of the boom assembly 44 may include altering a tilt of a first boom arm section 62, 64, 66, 68, 70, 72 of the boom assembly 44 relative to a second boom arm section 62, 64, 66, 68, 70, 72 of the boom assembly 44.

In some instances, a first set of data may be used to calculate a first spray quality index, with the first set of data being collected by the sensing system 56 prior to or during a spray operation. If the first spray quality index and/or one or more application variables deviates from a defined range, the boom assembly 44 may be adjusted. Once the boom assembly 44 is adjusted, a second set of data may be captured by the sensing system 56 and used to calculate a second spray quality index. The second spray quality index may be compared to the defined range and the boom assembly 44 may be adjusted if the second spray quality index deviates from the defined range. In addition, the second spray quality index and/or the application variables during the spray operation while the second spray quality index was calculated may be compared to the first spray quality index and/or the application variables during the spray operation while the first spray quality index was calculated to determine what result the adjustment to the boom assembly 44 had on the spray quality index. The computing system 152 may use the comparison to determine future movement of the boom assembly 44 based on the spray quality index deviating from the defined range. Additionally or alternatively, the computing system 152 may use the comparison to adjust one or more application variables. As such, the system 150 may form a closed-loop system for monitoring and altering the spray operating parameters of the spray operation to maintain a spray quality index within the defined range.

In various examples, the system 150 may implement machine learning engine methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system 152 and may be used to generate a predictive evaluation of the alterations to the boom assembly 44. For instance, the control module 176 may alter the boom adjustment system 52. In turn, the system 150 may monitor any changes to the spray quality index and/or any of the application variables. Each change may be fed back into the data analysis module 174 and the control module 176 for further alterations to the boom assembly 44.

In addition, various other components may be adjusted by the active control module 176 in response to the spray quality index and/or one or more application variables deviating from a defined range or threshold. For example, the active control module 176 may also adjust or alter the powertrain control system 22, the steering system 164, and/or the application assembly when the spray quality index and/or one or more application variables deviate from a defined range or threshold.

In several examples, the sensing data may provide data prior to the initiation of the spray operation. Based on the sensing data, the boom assembly 44 may be positioned in an initial position with the initial position being an estimate of a position in which the spray operation will be conducted within the defined range for the spray quality index and/or one or more application variables. In various examples, the data provided by the steering system 164 prior to the spray operation may include data from the weather station 60. The data from the weather station 60 includes a weather forecast. If, for example, the weather forecast calls for winds to increase or shifting directions later on, the boom assembly 44 position may be altered accordingly, and/or the user may be advised to spray sensitive areas first or wait until the wind shifts to a different direction.

Additionally or alternatively, the output of the control module 176 may be a suggested path for the spray application. In certain situations, it may be more advantageous to apply chemicals to a ground surface 20 in a specific direction based on the spray quality index and/or one or more application variables. In such situations, the control module 176 may advise the user which direction the sprayer 10 can apply chemicals. Inputs the computing system 152 may consider include the agricultural product being applied, crops being grown in adjacent fields, proximity from sensitive areas such as streams, wildlife habitat, etc.

Additionally, or alternatively, in some examples, the output of the control module 176 may alter the spray operation of the application system 38 to pause or otherwise change the application of the agricultural product in response to determining that the defined range for the spray quality index is unobtainable, even with adjustments to one or more components of the sprayer 10.

Additionally or alternatively, the output of the control module 176 may provide notifications and/or instructions to the user interface 32, a notification system 178, and/or a remote electronic device 180. In some examples, the display 34 of the user interface 32 may be capable of displaying information related to the spray quality index and/or one or more application variables.

In some embodiments, the notification system 178 may prompt visual, auditory, and tactile notifications and/or warnings when one or more airflow vectors exceeds a defined range of magnitudes or directions, the spray quality index deviates from a predefined range, and/or one or more functions of the sprayer 10 or the boom assembly 44 is altered by the computing system 152. For instance, brake lights and/or emergency flashers may provide a visual alert. A horn and/or speaker may provide an audible alert. A haptic device integrated into the cab 30 and/or any other location may provide a tactile alert. Additionally, the computing system 152 and/or the notification system 178 may communicate with the user interface 32 of the sprayer 10. In addition to providing the notification to the user, the computing system 152 may additionally store the location of the sprayer 10 at the time of the notification, which may be determined through a positioning system 170.

Further, the computing system 152 may communicate via wired and/or wireless communication with one or more remote electronic devices 180 through a transceiver 182. The network may be one or more of various wired or wireless communication mechanisms, including any combination of wired (e.g., cable and fiber) and/or wireless (e.g., cellular, wireless, satellite, microwave, and radio frequency) communication mechanisms and any desired network topology (or topologies when multiple communication mechanisms are utilized). Exemplary wireless communication networks include a wireless transceiver (e.g., a BLUETOOTH module, a ZIGBEE transceiver, a Wi-Fi transceiver, an IrDA transceiver, an RFID transceiver, etc.), local area networks (LAN), and/or wide area networks (WAN), including the Internet, providing data communication services.

The electronic device 180 may also include a display for displaying information to a user. For instance, the electronic device 180 may display one or more user interfaces and may be capable of receiving remote user inputs to set a predefined threshold for any of the application variables and/or to input any other information, such as the agricultural product to be used in a spray operation. In addition, the electronic device 180 may provide feedback information, such as visual, audible, and tactile alerts, and/or allow the user to alter or adjust one or more components of the sprayer 10 or the boom assembly 44 through the usage of the remote electronic device 180. It will be appreciated that the electronic device 180 may be any one of a variety of computing devices and may include a processor and memory. For example, the electronic device 180 may be a cell phone, mobile communication device, key fob, wearable device (e.g., fitness band, watch, glasses, jewelry, wallet), apparel (e.g., a tee shirt, gloves, shoes, or other accessories), personal digital assistant, headphones and/or other devices that include capabilities for wireless communications and/or any wired communications protocols.

Although the various control functions and/or actions are generally described herein as being executed by the computing system 152, one or more of such control functions/actions (or portions thereof) may be executed by a separate computing system 152 or may be distributed across two or more computing systems (including, for example, the computing system 152 and a separate computing system). For instance, in some embodiments, the computing system 152 may be configured to acquire data from the sensing system 56 for subsequent processing and/or analysis by a separate computing system (e.g., a computing system associated with a remote server). In other embodiments, the computing system 152 may be configured to execute the data analysis module 174, while a separate computing system (e.g., a sprayer computing system associated with the agricultural sprayer 10) may be configured to execute the control module 176 to control the spray operation of the agricultural sprayer 10 based on data and/or instructions transmitted from the computing system 152 that are associated with the spray quality index and/or one or more application variables.

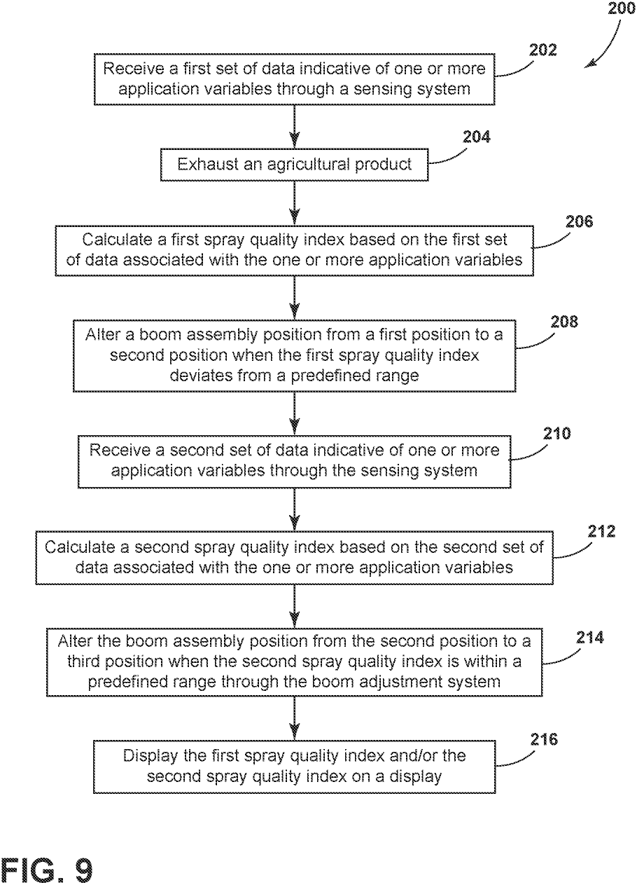

Referring now to FIG. 9, a flow diagram of some embodiments of a method 200 for operating an agricultural applicator is illustrated in accordance with aspects of the present subject matter. In general, the method 200 will be described herein with reference to the sprayer 10 and the system 150 described above with reference to FIGS. 1-8. However, the disclosed method 200 may generally be utilized with any suitable agricultural sprayer 10 and/or may be utilized in connection with a system having any other suitable system configuration. In addition, although FIG. 9 depicts steps performed in a particular order for purposes of illustration and discussion, the methods discussed herein are not limited to any particular order or arrangement. One skilled in the art, using the disclosures provided herein, will appreciate that various steps of the methods disclosed herein can be omitted, rearranged, combined, and/or adapted in various ways without deviating from the scope of the present disclosure.

As shown in FIG. 9, at (202), the method 200 can include receiving a first set of data indicative of one or more application variables through a sensing system. In accordance with aspects of the present subject matter, the sensing system may include one or more sensors, a weather station, and/or any other assembly, which may be installed on the sprayer and/or the boom assembly. In general, the sensing system may be configured to capture data indicative of one or more application variables associated with the application of an agricultural product to a ground surface (e.g., soil and/or plants).

At (204), the method 200 can include exhausting an agricultural product through one or more nozzle assemblies. In various embodiments, the first set of data is received prior to, during, and/or after exhausting the agricultural product.

At (206), the method 200 can include calculating a first spray quality index based on the first set of data associated with the one or more application variables with a computing system. As provided herein, the spray quality index represents a metric indicative of a spray operation coverage of a portion of a ground surface.

At (208), the method 200 can include altering a boom assembly position from a first position to a second position when the first spray quality index deviates from a predefined range through a boom adjustment system. The position adjustment assembly may include one or more actuators that are configured to alter a position of the boom assembly relative to the ground surface and/or the chassis of the sprayer. In some instances, the boom assembly can be a first height above the ground surface in the first position and a second height above the ground surface in the second position. The first height can be offset from the second height. Additionally or alternatively, the boom assembly can be oriented at a first angle relative to the ground surface in the first position and a second angle relative to the ground surface in the second position. The first angle can be offset from the second angle.

At (210), the method 200 can include receiving a second set of data indicative of one or more application variables through the sensing system. At (212), the method can include calculating a second spray quality index based on the second set of data associated with the one or more application variables with the computing system. At (214), the method can include altering the boom assembly position from the second position to a third position when the second spray quality index is within a predefined range through the boom adjustment system. In some instances, the boom assembly can be a second height above the ground surface in the second position and a third height above the ground surface in the third position. The second height can be offset from the third height. Additionally or alternatively, the boom assembly can be oriented at a second angle relative to the ground surface in the second position and a third angle relative to the ground surface in the third position. The second angle can be offset from the third angle.

At (216), the method 200 can include displaying the first spray quality index and/or the second spray quality index on a display. As provided herein, the display may be positioned within a cab of the sprayer, such as within a user interface within the cab. Additionally or alternatively, the display may be implemented within a remote electronic device.

In various examples, the method 200 may implement machine learning methods and algorithms that utilize one or several machine learning techniques including, for example, decision tree learning, including, for example, random forest or conditional inference trees methods, neural networks, support vector machines, clustering, and Bayesian networks. These algorithms can include computer-executable code that can be retrieved by the computing system and/or through a network/cloud and may be used to evaluate and update the boom deflection model. In some instances, the machine learning engine may allow for changes to the boom deflection model to be performed without human intervention.

It is to be understood that the steps of any method disclosed herein may be performed by a computing system upon loading and executing software code or instructions which are tangibly stored on a tangible computer-readable medium, such as on a magnetic medium, e.g., a computer hard drive, an optical medium, e.g., an optical disc, solid-state memory, e.g., flash memory, or other storage media known in the art. Thus, any of the functionality performed by the computing system described herein, such as any of the disclosed methods, may be implemented in software code or instructions which are tangibly stored on a tangible computer-readable medium. The computing system loads the software code or instructions via a direct interface with the computer-readable medium or via a wired and/or wireless network. Upon loading and executing such software code or instructions by the controller, the computing system may perform any of the functionality of the computing system described herein, including any steps of the disclosed methods.

The term “software code” or “code” used herein refers to any instructions or set of instructions that influence the operation of a computer or controller. They may exist in a computer-executable form, such as machine code, which is the set of instructions and data directly executed by a computer’s central processing unit or by a controller, a human-understandable form, such as source code, which may be compiled in order to be executed by a computer’s central processing unit or by a controller, or an intermediate form, such as object code, which is produced by a compiler. As used herein, the term “software code” or “code” also includes any human-understandable computer instructions or set of instructions, e.g., a script, that may be executed on the fly with the aid of an interpreter executed by a computer’s central processing unit or by a controller.

This written description uses examples to disclose the technology, including the best mode, and also to enable any person skilled in the art to practice the technology, including making and using any devices or systems and performing any incorporated methods. The patentable scope of the technology is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal language of the claims.

What is claimed is:

1. An agricultural system comprising:
a boom assembly supporting one or more nozzle assemblies there along;
a boom adjustment system operably coupled with the boom assembly;
a sensing system configured to capture data indicative of one or more application variables; and
a computing system communicatively coupled to the boom adjustment system and the sensing system, the computing system being configured to:
receive, from the sensing system, the data associated with the one or more application variables;
calculate a spray quality index based on the data associated with the one or more application variables, the spray quality index representing a metric indicative of a spray operation coverage of a portion of a ground surface; and
generate an output to change a position of the boom assembly through the boom adjustment system based at least in part on the calculated spray quality index deviating from a defined range.

2. The system of claim 1, wherein the change in the position of the boom assembly includes altering a height of the boom assembly relative to the ground surface.

3. The system of claim 1, wherein the change in the position of the boom assembly includes altering a tilt of the boom assembly relative to the ground surface.

4. The system of claim 1, wherein the change in the position of the boom assembly includes altering a height of a first boom arm section of the boom assembly relative to a second boom arm section of the boom assembly.

5. The system of claim 1, wherein the change in the position of the boom assembly includes altering a tilt of a first boom arm section of the boom assembly relative to a second boom arm section of the boom assembly.

6. The system of claim 1, wherein the boom adjustment system includes one or more actuators.

7. The system of claim 1, wherein the data associated with the one or more application variables is received prior to the one or more nozzle assemblies exhaust an agricultural product.

8. The system of claim 1, wherein the data associated with the one or more application variables is received while the one or more nozzle assemblies exhaust an agricultural product.

9. The system of claim 1, wherein the computing system is further configured to:
generate a second output in the form of one or more notifications that are presented on a display.

10. A method for an agricultural application operation, the method comprising:
receiving, through a sensing system, a first set of data indicative of one or more application variables;
calculating, with a computing system, a first spray quality index based on the first set of data associated with the one or more application variables, the spray quality index representing a metric indicative of a spray operation coverage of a portion of a ground surface;
altering, through a boom adjustment system, a boom assembly position from a first position to a second position when the first spray quality index deviates from a predefined range; and
receiving, through the sensing system, a second set of data indicative of one or more application variables.

11. The method of claim 10, further comprising:
calculating, with the computing system, a second spray quality index based on the second set of data associated with the one or more application variables; and
altering, through the boom adjustment system, the boom assembly position from the second position to a third position when the second spray quality index is within a predefined range.

12. The method of claim 10, further comprising:
displaying the first spray quality index on a display.

13. The method of claim 10, further comprising:
exhausting, through one or more nozzle assemblies, an agricultural product, wherein the first set of data is received prior to exhausting the agricultural product.

14. The method of claim 10, wherein the boom assembly is a first height above the ground surface in the first position and a second height above the ground surface in the second position, and wherein the first height is offset from the second height.

15. The method of claim 10, wherein the boom assembly is oriented at a first angle relative to the ground surface in the first position and a second angle relative to the ground surface in the second position, and wherein the first angle is offset from the second angle.

16. An agricultural system comprising:
a boom assembly supporting one or more nozzle assemblies there along;
a boom adjustment system operably coupled with the boom assembly;
a sensing system configured to capture data indicative of one or more application variables; and
a computing system communicatively coupled to the boom adjustment system and the sensing system, the computing system being configured to:
receive, from the sensing system, the data associated with the one or more application variables; and
generate an output to change a position of the boom assembly through the boom adjustment system based at least in part on the one or more application variables deviating from a defined operating range.

17. The system of claim 16, wherein the computing system is further configured to:
calculate a spray quality index based on the data associated with the one or more application variables, the spray quality index representing a metric indicative of a spray operation coverage of a portion of a ground surface.

18. The system of claim 16, wherein the change in the position of the boom assembly includes altering a height of the boom assembly relative to a ground surface.

19. The system of claim 16, wherein the change in the position of the boom assembly includes altering a tilt of the boom assembly relative to a ground surface.

20. The system of claim 16, wherein the sensing system includes at least one sensor positioned along the boom assembly and a weather station.
